(19) United States
(12) Patent Application Publication
(10) Pub. No.: US 2010/0084386 A1
(43) Pub. Date: Apr. 8, 2010

(54) LASER PROCESSING MACHINE

(75) Inventors: Yukiyasu Masuda, Ota-ku (JP); Ryugo Oba, Ota-ku (JP)

Correspondence Address: GREER, BURNS & CRAIN, 300 S WACKER DR, 25TH FLOOR, CHICAGO, IL, 60606, US

(73) Assignee: DISCO CORPORATION, Tokyo (JP)

(21) Appl. No.: 12/551,977

(22) Filed: Sep. 1, 2009

(30) Foreign Application Priority Data
Oct. 3, 2008 (JP) 2008-258187

(51) Int. Cl. B23K 26/38

(52) U.S. Cl. 219/121.67

(57) ABSTRACT

A laser processing machine is provided in which a flat plate-like mask is disposed between a mirror and a relay lens in an optical system so as to be perpendicular to the optical path of a laser beam. The mask is horizontally shiftable. The laser beam is allowed to pass through an elongate trapezoidal aperture formed in the mask to extend in the shifting direction. The sectional shape of a portion of the laser beam passing through the aperture of the wafer is focused on the wafer. Shifting the mask can adjust the width of an image of the laser beam focused on the wafer.

### BACKGROUND OF THE INVENTION

1. Field of the Invention

The present invention relates to a laser processing machine that emits a laser beam to a workpiece such as a semiconductor wafer to form a groove, a slit, etc.

2. Description of the Related Art

In the semiconductor device chip production process, a large number of rectangular chip areas are sectioned by predetermined dividing lines arranged in a lattice pattern on the front surface of a generally disklike semiconductor wafer. An electronic circuit such as an IC or LSI is formed in each of the chip areas. Thereafter, necessary processing such as rear surface grinding is performed on the wafer, which is then cut and divided, i.e., diced, along the predetermined dividing lines. Thus, the chip areas are obtained as semiconductor chips. The semiconductor chips thus obtained are packaged by resin sealing and are widely used in various electric or electronic devices such as mobile phones, personal computers, etc.

Means for dicing a wafer into individual semiconductor chips is generally blade dicing in which a thin disklike blade rotated at a high-speed is incised into the wafer. On the other hand, in recent years, laser dicing has been developed and employed in which a wafer is diced by irradiating the wafer with a laser beam capable of passing through the wafer along predetermined dividing lines. (See Japanese Patent Laid-open No. Hei 10-305420.) In the laser dicing, a technology is proposed in which the shape of an image of a laser beam focused on a workpiece is deformed into a desired shape by a mask to adjust a processing line. (See Japanese Patent Laid-open No. Hei 2005-209719.)

As described in Japanese Patent Laid-open No. Hei 2005-209719, the technology of allowing a laser beam to pass though an aperture formed in a mask involves conceivable application in which the width of the image is changed to make it possible to adjust the width of a processing line such as a groove, a slit or the like to be formed, as well as deforming the shape of the image of the laser beam focused on the workpiece. However, this needs work in which a plurality of masks different from each other in the width of the aperture are prepared and the mask is selectively replaced according to the width of the processing line. Thus, complication and a cost rise are concerned as defects.

### SUMMARY OF THE INVENTION

Accordingly, it is an object of the present invention to provide a laser processing machine that can easily adjust the width of an image of a laser beam focused on a workpiece, i.e., the width of a processing line, without the necessity of replacement of a mask, and consequently to streamline work and to suppress a cost rise.

In accordance with an aspect of the present invention, there is provided a laser processing machine including: holding means for holding a workpiece; and laser processing means including an oscillator adapted to emit a laser beam to a workpiece held by the holding means and an optical system adapted to direct the laser beam to the workpiece and focus the laser beam onto a desired position of the workpiece; wherein the optical system of the laser processing means includes a mask having a transmitting portion adapted to transmit the laser beam therethrough and shielding part of an irradiation area of the laser beam by allowing the laser beam to pass through the transmitting portion, and mask shifting means for shifting the mask in a direction generally perpendicular to an optical path of the laser beam to vary a shielding area of the laser beam passing through the transmitting portion to vary a width of an image of the laser beam focused on the workpiece.

According to the present invention, the laser beam emitted from the oscillator passes through the transmitting portion of the mask, and is directed to and focused on the workpiece held by the holding means. The width of the image of the laser beam focused on the workpiece corresponds to the width of the transmitting portion. By allowing the mask shifting means to shift the mask, the width of the image, i.e., the width of the processing line is varied. Thus, such simple operation as to allow the mask shifting means to shift the mask can easily adjust the width of the processing line processed by the laser beam into a desired width.

An embodiment of varying the width of the image of the laser beam focused on the workpiece involves an embodiment in which the transmitting portion of the mask is formed in such a taper as to vary its width as it goes toward the shifting direction of the mask.

Incidentally, the workpiece referred to in the present invention is not particularly restrictive; however, examples of the workpiece include a semiconductor wafer such as a silicon wafer; an adhesive member such as a die attach film (DAF) provided on the rear surface of a wafer for chip-mounting; a package for semiconductor product; ceramic, glass-based, silicon-based substrates, various drivers such as LCD drivers for controllably driving various electronic parts or liquid crystal display devices; and various processing materials requiring micron-order accuracy.

The present invention can easily vary the width of the image of the laser beam focused on the workpiece, i.e., the width of the processing line, without the necessity of replacement of the mask. Thus, the invention provides an effect of streamlining work and suppressing a rise in cost.

The above and other objects, features and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a perspective view of a semiconductor wafer subjected to laser processing by a laser processing machine according to an embodiment of the present invention;

FIG. 2 is a perspective view illustrating a laser processing machine according to the embodiment of the present invention;

FIG. 3 schematically illustrates a configuration of laser processing means installed in the laser processing machine according to the embodiment;

FIGS. 4A to 4C are perspective views illustrating the function of a mask according to the present embodiment;

FIG. 5 is a plan view illustrating a state where a laser beam is directed into an aperture of the mask;

FIGS. 6A to 6G are plan views illustrating various shapes of the apertures formed in the mask;

FIG. 7 is a perspective view illustrating a mask and mask shifting means according to a first other embodiment;

FIG. 8A is a perspective view illustrating a mask and mask shifting means according to a second other embodiment; and

FIG. 8B is a plan view of a mask alone.

### DETAILED DESCRIPTION OF THE PREFERRED EMBODIMENTS

An embodiment of the present invention will hereinafter be described with reference to the drawings.

### [1] Semiconductor Wafer

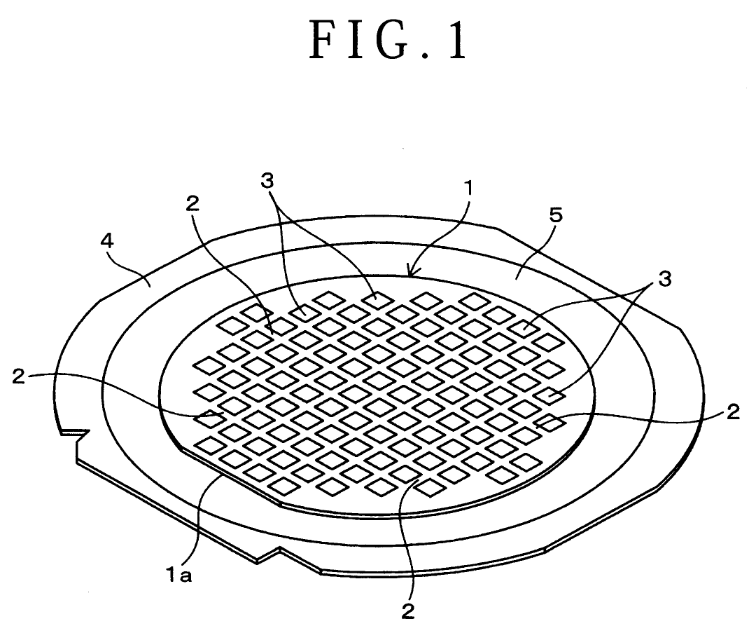

Reference numeral 1 in FIG. 1 denotes a semiconductor wafer which is a workpiece in the embodiment. The semiconductor wafer will hereinafter be abbreviated to the wafer. The wafer 1 is a disklike one made of a single crystal material such as silicon or the like. The wafer 1 is formed at a part of an outer circumferential portion with an orientation flat 1a as a mark indicating a crystal orientation. The front surface of the wafer 1 is sectioned into a large number of rectangular chips 3 by predetermined dividing lines 2 formed in a lattice-like pattern. Electronic circuits such as ICs, LSIs not illustrated are formed on the front surface of the chips 3. The wafer 1 is cut along all the predetermined dividing lines 2 and diced into a large number of the chips 3.

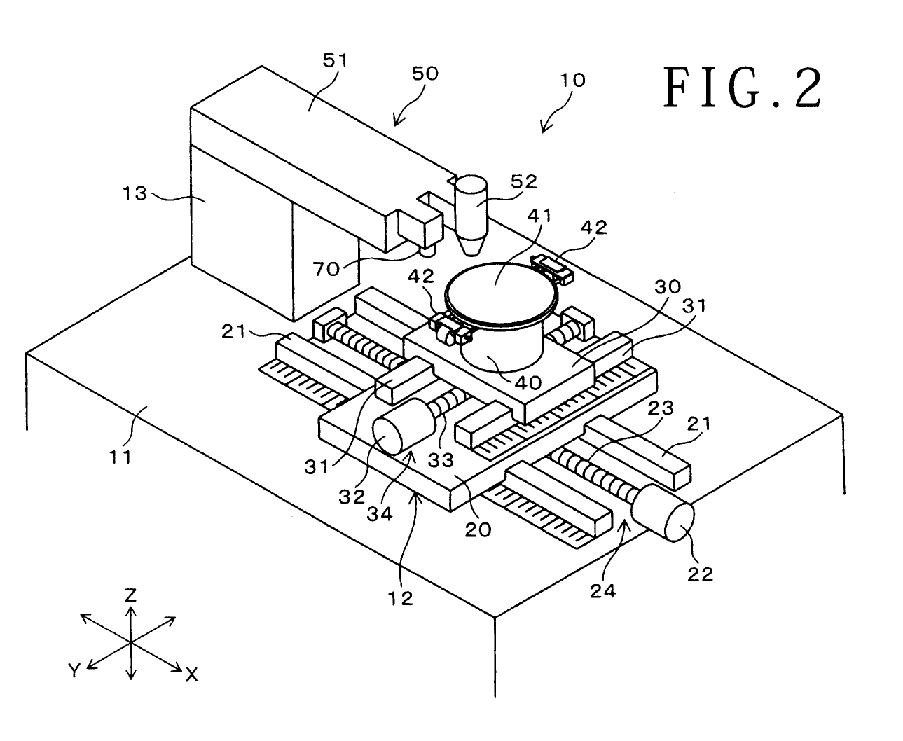

Cutting along the predetermined dividing lines 2 is performed by full-cut by means of a blade after the formation of grooves by laser beam irradiation or by full-cut only by laser beam irradiation. Either way, the predetermined dividing lines 2 are irradiated with a laser beam for laser processing. The laser processing in this case is the groove formation or the full-cut mentioned above, which is preferably performed by a laser processing machine 10 according to the embodiment illustrated in FIG. 2.

When supplied to the laser processing machine 10, the wafer 1 is held on the inside of an annular frame 4 via an adhesive tape 5 as illustrated in FIG. 1. The frame 4 is a rigid plate made of metal or the like. The adhesive tape 5 has an adhesive surface on one side, to which the frame 4 and the rear surface of the wafer 1 are stuck. The wafer 1 held by the adhesive tape 4 and the frame 5 in this way is conveyed by handling the frame 5 and set on the laser processing machine 10. A description is below given of the laser processing machine 10.

### [2] Laser Processing Machine

### [2-1] Overall Configuration

In the laser processing machine 10 of the present embodiment, the wafer 1 is horizontally set on a disklike chuck table (holding means) 41 with the front surface of the wafer 1 facing upward. A laser beam is directed to the predetermined dividing lines 2 from a laser head 52 of laser processing means 50. As illustrated in FIG. 2, the laser processing machine 10 has a base 11, on which an X-Y traveling table 12 is installed so as to be movable in horizontal X- and Y-directions. The chuck table 41 mentioned above is installed on the X-Y traveling table 12. While the X-Y traveling table 12 is moved in the X- and Y-directions, a laser beam is directed from the laser head 52 to the predetermined dividing lines of the wafer 1.

The X-Y traveling table 12 is configured by combining an X-axis base 20 installed on the base 11 so as to be movable in the X-direction with a Y-axis base 30 installed on the X-axis base 20 so as to be movable in the Y-direction. The X-axis base 20 is slidably mounted to a pair of parallel guide rails 21 secured to the base 11 to extend in the X-direction. In addition, the X-axis base 20 is moved in the X-direction by an X-axis drive mechanism 24 where a ball screw 23 is operated by a motor 22. On the other hand, the Y-axis base 30 is slidably mounted to a pair of horizontal guide rails 31 secured onto the X-axis base 20 so as to extend in the Y-direction. In addition, the Y-axis base 30 is moved in the Y-direction by a Y-axis drive mechanism 34 where a ball screw 33 is operated by a motor 32.

A cylindrical chuck base 40 is secured to the upper surface of the Y-axis base 30. The chuck table 41 is supported on the chuck base 40 so as to be turnable around a Z-direction (the up-down direction) as a turning axis. The chuck table 41 is of a generally known vacuum chuck type where the wafer 1 is suck and held by vacuum suction action. In addition, the chuck table 41 is turned in one or both directions by a turning drive mechanism, not illustrated, housed in the chuck base 40. A pair of clamps 42 adapted to removably hold the frame 5 are arranged on the periphery of the chuck table 41 at positions apart from each other by 180°. The clamps 42 are mounted to the chuck base 40.

The X-Y traveling table 12 of this case is such that the X-directional traveling of the X-axis base 20 is set as processing-transfer where a laser beam is directed along the predetermined dividing line 2. The Y-directional traveling of the Y-axial base 30 is set as indexing-transfer where the predetermined dividing lines 2 to be irradiated with a laser beam are switched. Incidentally, processing-transfer and indexing-transfer directions may be reversed, that is, the Y-direction and the X-direction may be set as the processing-transfer and the indexing-transfer, respectively. In short, the processing-transfer and indexing-transfer directions are not restrictive.

A description is next given of the laser processing means 50. The laser processing means 50 includes a rectangular parallelepipedic casing 51 extending in the Y-direction toward the upside of the chuck table 41. The casing 51 supports the laser head 52 at the leading end. The casing 51 is provided on a column 13 provided upright on the upper surface of the base 11 so as to be movable vertically along the Z-direction and is moved upward and downward by an up-down drive mechanism, not illustrated, housed in the column 13.

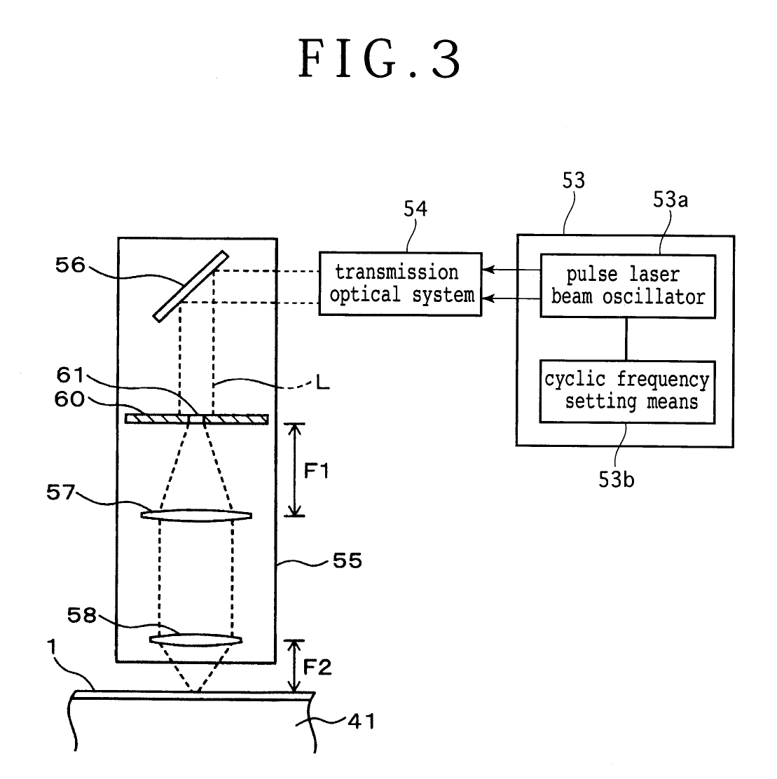

Referring to FIG. 3, pulse laser beam oscillation means 53 and a transmission optical system 54 are housed as constituent elements of the laser processing means 50 in the casing 51. The pulse laser beam oscillating means 53 has a pulse laser beam oscillator 53a composed of a YAG laser oscillator or a YVO4 laser oscillator. The pulse laser beam oscillator 53a is attached with cyclic frequency setting means 53b. The transmission optical system 54 includes an appropriate optical element such as a beam splitter and the like.

As illustrated in FIG. 3, a collector optical system 55 is housed in the laser head 52. The collector optical system 55 includes a mirror 56; a mask 60 disposed below the mirror 56; and two sets of lenses (a relay lens 57 and an objective lens 58) disposed below the mask 60. The mirror 56 is adapted to orthogonally reflect a laser beam L, horizontally emitted from the pulse laser beam oscillator 53a through the transmission optical system 54, toward the mask 60 below the mirror to make its optical path parallel to the Z-direction in FIG. 2.

The mask 60 transmits part of the laser beam L reflected by the mirror 56 to deform the transverse sectional shape of the laser beam L into a desired shape from its original circular shape. Since the mask 60 pertains to the present invention, it is detailed later. The laser beam L that has passed through the mask 60 passes through the relay lens 57 and the objective lens 58 and is directed to the predetermined dividing line 2 of the wafer 1 held by the chuck table 41.

As illustrated in FIG. 2, image pickup means 70 is disposed at the leading end of the casing 51 and adjacent to the laser head 52. The image pickup means 70 picks up and detects an irradiation area of the laser beam emitted from the laser head 52. In addition, the image pickup means 70 includes illumination means for illuminating the wafer 1 set on the chuck table 41; and an image pickup device which is composed of a CCD or the like picking up an image by use of a visible beam. The laser processing machine of the present embodiment sends image data on the front surface of the wafer 1 imaged by the image pickup means 70 to control means not illustrated and based on the alignment performed by the control means performs laser processing on the predetermined dividing lines 2 of the wafer 1. The alignment in this case means work for image-processing the image data and detecting an area to be irradiated with a laser beam.

### [2-2] Outline of Operation

The above is the basic configuration of the laser processing machine 10. Laser processing performed by the machine 10 is as below. The wafer 1 to be laser-processed is first held by the frame 5 via the adhesive tape 4 as illustrated in FIG. 1. The wafer 1 is concentrically placed on the upper surface of the chuck table 41 that has previously been vacuum operated with the front surface thereof formed with the chips 3 facing upward and sucked and held by vacuum suction action. In addition, the frame 5 is held by the clamps 42.

Next, the X-Y traveling table 12 is moved in the X- and Y-directions so that the wafer 1 is moved to a position immediately below the image pickup means 70. The front surface of the wafer 1 is imaged by the image pickup means 70. The image data on the front surface of the wafer 1 imaged by the image pickup means 70 is subsequently sent to the control means. The control means performs the alignment mentioned above and creates and stores operation data needed to perform laser processing on the predetermined dividing lines 2.

The casing 51 of the laser processing means 50 is next moved upward and downward so that the distance between the laser head 52 and the wafer 1 may be adjusted to a distance suitable for laser processing on the wafer 1. Next, while processing-transfer is performed based on the above operation data to move the X-axial base 20 of the X-Y traveling table 12 in the X-direction, the laser processing (groove formation and full-cut) and indexing-transfer are repeated. The laser processing is such that a laser beam is directed to one predetermined dividing line 2. The indexing-transfer is such that the Y-axial base 20 is moved in the Y-direction so that a laser beam may be directed to a predetermined dividing line 2 to be laser processed. In this way, laser processing is performed on a large number of the predetermined dividing lines 2 extending in one direction. After the laser processing on all the predetermined dividing lines 2 extending one direction has been finished, the chuck table 41 is turned by 90° and laser processing is performed in the same way on all predetermined dividing lines 2 extending in the other direction perpendicular to the one direction.

An example of the conditions of laser beam irradiation for laser processing is as below.

| | |
|---|---|
| Light source | YAG laser or YVO4 laser |
| Wavelength | 355 nm |
| Output (pulse energy) | 1.0 to 2.0 W |
| Repetition frequency | 50 kHz |
| Pulse width | 10 ns |

### [2-3] Picking up a Chip

After the laser processing has been finished by irradiating all the predetermined dividing lines 2 with a laser beam, the wafer 1 is shifted to a subsequent step corresponding to the mode of the laser processing and the chips 3 are finally obtained. For example, if the laser processing is groove formation, the wafer 1 is full-cut by the remaining thickness thereof by the blade for dicing. The chips 3 are each peeled off and picked up from the adhesive tape 4. Alternatively, if the laser processing is full-cut, dicing is already completed. Thereafter, the chips are each peeled off and picked up from the adhesive tape 4.

### [3] Mask

### [3-1] Configuration of the Mask

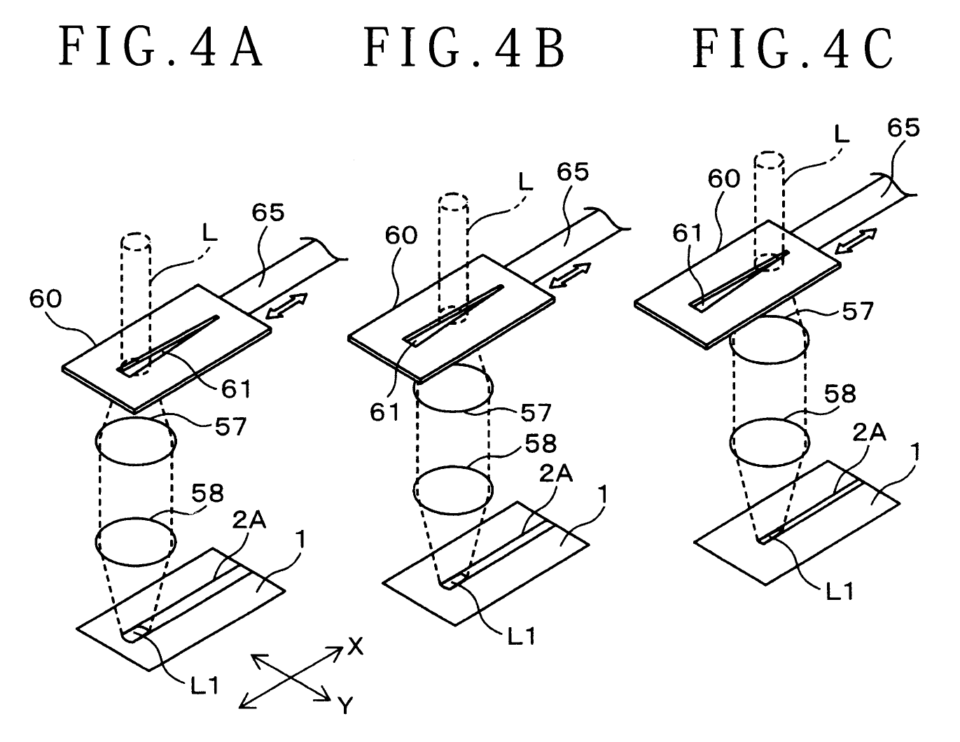

A description is next given of the mask 60 of the collector optical system 55. Referring to FIGS. 4A, 4B and 4C, the mask 60 is rectangular plate-like and is horizontally installed at an appropriate position between the mirror 56 and the relay lens 57. An arm 65 constituting part of mask shifting means is joined to longitudinal one end of the mask 60. Drive means such as a cylinder or the like is connected to the end of the arm 65 to reciprocate the mask 60 in directions indicated with arrows. This reciprocative direction is a direction parallel to the processing-transfer (the X-direction in FIGS. 2 and 4) and perpendicular to the optical path of the laser beam L parallel to the z-direction reflected by the mirror 56 and directed toward the mask 60.

The material of the mask 60 is selected from ones insusceptible to even laser beam irradiation. For example, stainless steel (SUS), ceramics or the like are used. In particular, stainless steel is suitable because of reflecting a laser beam so that it is hard to be heated thereby. The mask 60 is formed at the center with a slit-like aperture (transmitting portion) 61 adapted to receive a laser beam passed therethrough. This aperture 61 is formed like an elongate symmetrical trapezoid extending in the reciprocative direction of the mask 60. The width of the aperture 61 varies at a given rate as it goes toward one direction of the reciprocative directions. The width of the broad side end of the aperture 61, i.e., the maximum width is set to a value equal to or smaller than the diameter of the circular transverse surface of a laser beam. If the mask 60 reciprocates, a laser beam passes through between one end and the other end of the aperture 61. At this time, the optical path of the laser beam passes the symmetric line of the aperture 61. In short, the center of the laser beam coincides with the Y-directional center of the aperture 61.

### [3-2] Function and Effect of the Mask

According to the collector optical system 55 including the mask 60, the laser beam L reflected toward the mask 60 by the mirror 56 passes through the aperture 61 of the mask 60. Both end edges of the aperture 61 shield a portion of the irradiation area of the laser beam L so that the transverse surface shape is formed into a shape corresponding to the aperture 61. The laser beam L passes through the relay lens 57 and the object lens 58 and is directed to and focused on the predetermined dividing line 2 of the wafer 1. As illustrated in FIGS. 4A, 4B and 4C, the shape of an image L1 of the laser beam L formed on the wafer 1 becomes similar to the sectional shape of the portion passing through the aperture 61. The width of the image L1 becomes a width of a processing line 2A formed on the predetermined dividing line 2 by laser processing. If the laser processing is processing for forming a groove, the width of an image is equivalent to that of the groove.

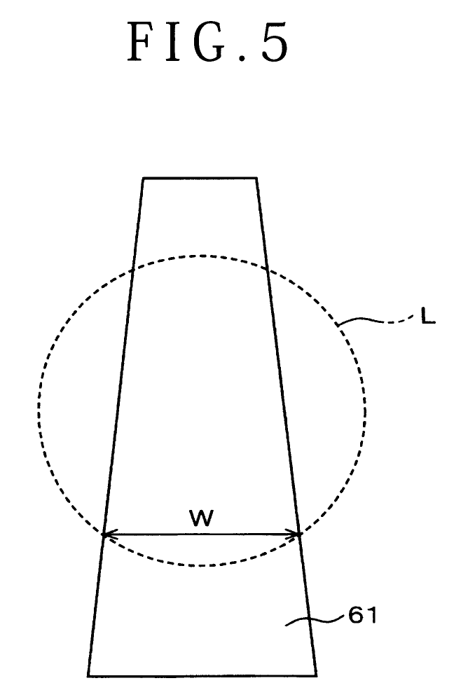

The distance between the mask 60 and the relay lens 57 is set to a value equal to a focal length F1 of the relay lens 57. In addition, the distance between the objective lens 58 and the wafer 1 is set to a value equal to a focal length F2 of the objective lens 58. In this case, as well known in the art, image magnification is F2/F1. As illustrated in FIG. 5, for example, the maximum irradiation width of the irradiation portion of the laser beam L in the aperture 61 of the mask 60 is W. If F1=651 mm and F2=25 mm, the image magnification is approximately 0.038-fold so that processing width is 0.038 W.

In this way, the mask 60 is shifted to vary the width of the laser beam L passing through the aperture 61, whereby the width of the processing line 2A can be varied. That is to say, such simple operation as to shift the mask 60 can easily adjust the width of the processing line 2A into a desired width. Since both the left and right end edges of the opening 61 are inclined in a tapered manner with respect to the shifting direction of the mask 60, the width of the image L1 can be adjusted in a stepless manner. In other words, by sifting the mask 60, the processing line 2A formed on the wafer 1 can be controlled with a high degree of accuracy. Alternatively, portions different in width from each other can continuously be formed in the processing line 2A.

FIGS. 4A, 4B and 4C illustrate states where the laser beam L passes through the aperture 61 at different positions. FIG. 4A illustrates a state where the laser beam L passes through the broad side end of the aperture 61. FIG. 4B illustrates a state where the laser beam L passes through an intermediate portion of the aperture 61. FIG. 4C illustrates a state where the laser beam L passes through the narrow side end of the aperture 61. The widths of the processing line 2A which are the widths of the image L1 focused on the wafer 1 are set to smaller values in the order of FIGS. 4A, 4B and 4C.

According to the present embodiment, it is not necessary to perform such cumbersome work as to prepare a plurality of masks different in aperture width for replacement. By shifting the mask 60 as described above, the width of the processing line 2A formed on the wafer 1 can easily be adjusted to a desired width. Thus, the adjusting work for the width of the processing line 2A can be streamlined and a rise in cost can be suppressed.

### [3-3] Various Shapes of the Aperture

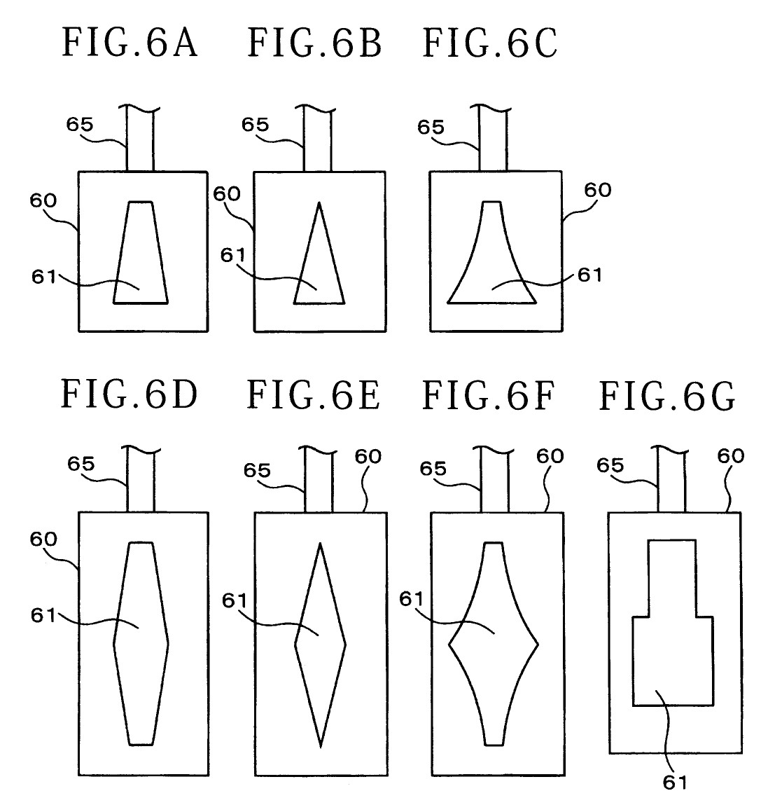

The shape of the aperture 61 formed in the mask 60 is not limited to the embodiment described above. If the shape of the aperture can change the width of the image of the laser beam focused on the wafer 1 along with the shifting of the mask 60, any shape may be applicable. FIGS. 6A to 6G exemplify the various shapes of the aperture 61. The mask 60 reciprocates in the arrow directions. The shapes of the aperture 61 are described below. FIG. 6A illustrates a trapezoid similar to that of the above embodiment. FIG. 6B illustrates an isosceles triangle. FIG. 6C illustrates another trapezoid having both left and right end edges protruding inward. With such apertures 61, if the mask 60 is moved in one direction, the width of the image of the laser beam is decrescent or increscent.

The respective apertures 61 of FIGS. 6D, 6E and 6F are each formed by combining two of the apertures 61 of a corresponding one of FIGS. 6A, 6B and 6C into one so as to be vertically symmetrical in the figure. If the mask 60 is moved in one direction, these apertures 61 make the width of the image of the laser beam increscent and then decrescent. An aperture 61 of FIG. 6G is shaped in a convexity having the two-stepped dimensions of the width.

The apertures 61 of FIGS. 6A to 6F are each such that the width of the image can be adjusted in a stepless manner. The aperture 61 of FIG. 6G is such that the image width is adjusted two-stepwise. Incidentally, the width of the aperture 61 may be varied stepwise so as to be able to adjust the image width more stepwise than two-stepwise (e.g. three-, four- or more stepwise). If such a method of switching the processing width stepwise is employed, the laser beam is emitted uniformly toward the end of the processing line. Thus, processing is further stabilized.

### [4] Masks and the Mask Shifting Means According to Other Embodiments

The mask and mask shifting means of the present invention are not limited to the above embodiment but various modes are conceivable. Masks and the mask shifting means according to other embodiments will hereafter be exemplified.

### [4-1] First Other Embodiment

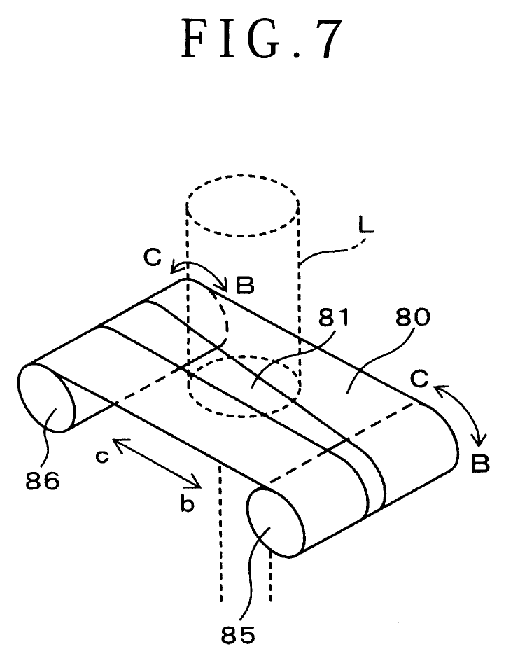

Reference numeral 80 in FIG. 7 illustrates a mask according to a first other embodiment. The mask 80 is a flexible belt-like one and is disposed perpendicularly to the optical path of the laser beam L. The mask 80 is formed at the widthwise center with a slit-like aperture (the transmitting portion) 81 adapted to receive a laser beam L passed therethrough. The aperture 81 is formed like an elongate symmetrical taper extending in the longitudinal direction of the mask 80. The width of the aperture 81 varies at a given rate as it goes from one end to the other end of the mask 80. Both end portions of the mask 80 are wound around rollers 85, 86 (mask shifting means) which are rotatably disposed parallel to each other. The mask 80 is reciprocated according to the rotating directions of the rotating rollers 85, 86.

If the rollers 85, 86 are rotated in the direction of arrow B, the mask 80 is wound around the roller 85 to be shifted in a b-direction. As the mask 80 is shifted in the b-direction, the width of the aperture 81 adapted to receive a laser beam L passed therethrough is gradually broadened so that the width of the image focused on the wafer 1 is broadened accordingly. If the rollers 85, 86 are rotated in the direction of arrow C, the mask 80 is wound around the roller 86 to be shifted in a c-direction. As the mask 80 is shifted in the c-direction, the width of the aperture 81 adapted to receive the laser beam L passed therethrough is gradually narrowed so that the width of the image focused on the wafer 1 is narrowed accordingly. In short, by rotating the rollers 85, 86 to shift the mask 80, the width of the image of the laser beam 1 focused on the wafer 1 can be adjusted. The rollers 85, 86 are rotated by a rotation drive mechanism not illustrated so that the mask 80 is held in a constantly extensile state. Incidentally, the rollers 85, 86 may be such that one of them is used as the drive side and the other is used as the driven side. Alternatively, both of the rollers 85, 86 may be driven.

### [4-2] Second Other Embodiment

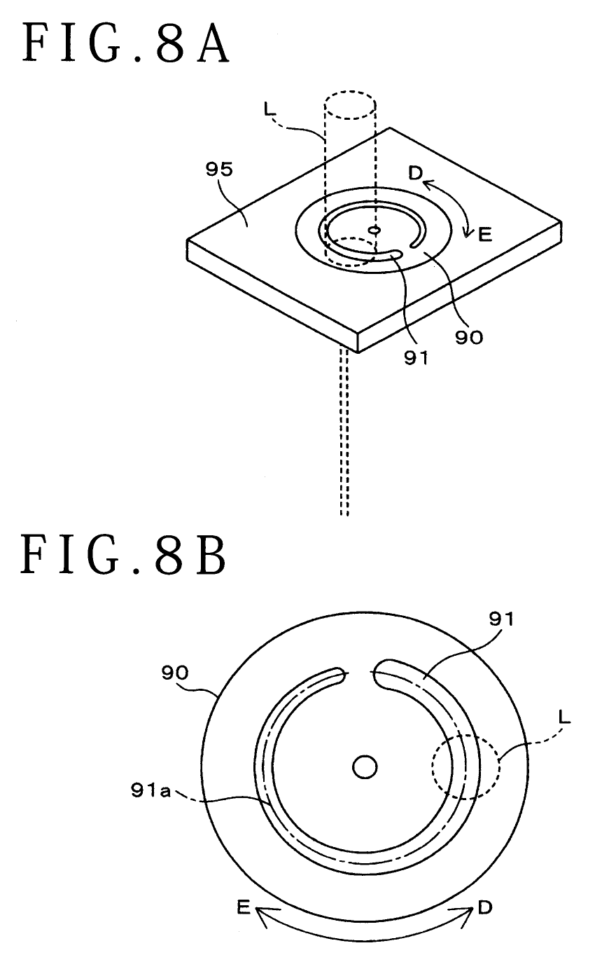

Reference numeral 90 in FIGS. 8A and 8B illustrate a mask according to a second other embodiment. The mask 90 is disklike and is turnably fitted into and supported by a rectangular plate-like frame 95. The mask 90 has a central turning axis parallel to the optical path of a laser beam L and a surface-direction disposed perpendicularly to the laser beam L. The mask 90 is formed with an annular aperture (the transmitting portion) 91. The aperture 91 is not formed along the whole circumference: it is formed like a discontinuous circle having one end and the other end close to each other. The width of the aperture 91 varies at a given rate as it goes from one end to the other end. An annular centerline 91a passing through the widthwise center of the aperture 91 is concentric to the mask 90.

The mask 90 is disposed so that the optical path of the laser beam L is perpendicular to and passes the centerline 91a of the aperture 91. The mask 90 is turned in two directions (D- and E-directions) by a turning drive mechanism not illustrated. As the mask 90 is turned in the D-direction, the width of the aperture 91 adapted to receive the laser beam L passed therethrough is narrowed so that the width of the image focused on the wafer 1 is narrowed accordingly. As the mask 90 is turned in the E-direction, the width of the aperture 91 adapted to receive the laser beam L passed therethrough is broadened so that the width of the image focused on the wafer 1 is broadened accordingly. In short, by turning the mask 90 to turn the aperture 91, the width of the image of the laser beam L focused on the wafer 1 can be adjusted.

In the first and second other embodiments described above, even if the shifting amount of the mask is large, the space needed to shift the mask does not vary regardless of the shifting amount. This can provide an effect that even if the space adapted to dispose the mask therein is small, the variation of the width of the aperture can be increased and space-saving can be achieved.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A laser processing machine comprising:
holding means for holding a workpiece; and
laser processing means including an oscillator adapted to emit a laser beam to a workpiece held by the holding means and an optical system adapted to direct the laser beam to the workpiece and focus the laser beam onto a desired position of the workpiece;
wherein the optical system of the laser processing means includes
a mask having a transmitting portion adapted to transmit the laser beam therethrough and shielding part of an irradiation area of the laser beam by allowing the laser beam to pass through the transmitting portion, and
mask shifting means for shifting the mask in a direction generally perpendicular to an optical path of the laser beam to vary a shielding area of the laser beam passing through the transmitting portion to vary a width of an image of the laser beam focused on the workpiece.

2. The laser processing machine according to claim 1, wherein the transmitting portion is formed like a taper whose width varies as the width goes toward the shifting direction of the mask.
